(19) United States
(12) Patent Application Publication
(10) Pub. No.: US 2009/0179357 A1
(43) Pub. Date: Jul. 16, 2009

(54) Method and Apparatus for Producing Porous Silica

(75) Inventors: Masami Murakami, Chiba (JP); Shunsuke Oike, Chiba (JP); Yoshito Kurano, Yamaguchi (JP); Makoto Aritsuka, Chiba (JP); Hiroko Wachi, Chiba (JP)

Correspondence Address: BUCHANAN, INGERSOLL & ROONEY PC, POST OFFICE BOX 1404, ALEXANDRIA, VA, 22313-1404, US

(73) Assignee: MITSUI CHEMICALS, INC., MINATO-KU TOKYO (JP)

(21) Appl. No.: 11/989,776

(22) PCT Filed: Aug. 10, 2006
(86) PCT No.: PCT/JP2006/315869

§ 371 Date: Jan. 31, 2008

(51) Int. Cl. B29C 67/00

(52) U.S. Cl. 264/414; 425/174.4

(57) ABSTRACT

There are provided a method for producing porous silica and a porous silica film having low specific dielectric constant and high mechanical strength, that are preferably applicable to optical functional materials, electronic functional materials or the like, and a method for producing an interlayer insulating film, a semiconductor material and a semiconductor apparatus and a producing apparatus, which use the porous silica film. A solution containing a hydrolysis-condensation product of alkoxysilanes and a surfactant is dried to form a composite to which are then applied in the following order an ultraviolet ray irradiation treatment and a hydrophobic treatment with the use of an organic silicon compound having an alkyl group. By forming the composite by drying the solution on a substrate, the porous silica film is obtained.

### TECHNICAL FIELD

The present invention relates to a method for producing porous silica. More specifically, the present invention relates to a method for producing a porous silica film having low specific dielectric constant and high mechanical strength, and applicable to an optical functional material, an electronic functional material or the like, a method for producing an interlayer insulating film, a semiconductor material and a semiconductor apparatus that use the porous silica film, and an apparatus for producing the sames.

### BACKGROUND ART

Porous inorganic oxides having uniform mesopores, that are synthesized by utilizing self-organization of an organic compound and an inorganic compound, are known to have a larger pore volume, a larger surface area or the like than a conventional porous inorganic oxide such as zeolite, so that application of such a porous inorganic oxide to a catalyst carrier, a separation absorbent, a fuel cell, a sensor or the like has been studied.

A problem to be solved when using a porous silica film that is one of such oxides having uniform mesopores for an optical functional material, an electric functional material or the like, especially for a semiconductor interlayer insulating film, is to satisfy both porosity and mechanical strength of the film. That is to say, if the porosity in the film increases, specific dielectric constant of the film decreases to be closer to air of 1, but internal space increases because of the high porosity, resulting that the mechanical strength is considerably lowered. In addition, the mesopores are formed and the surface area is extremely increased, and therefore H₂O having high specific dielectric constant is easily adsorbed, resulting that the specific dielectric constant decreased by increasing the porosity increases to the contrary due to the adsorption.

There has been proposed a method for introducing a hydrophobic functional group into a film as a method for preventing the adsorption of H₂O. For example, a method for preventing water adsorption by trimethylsilylating a silanol group in pores (refer to International Publication WO00/39028). In addition, it has been reported that, by bringing a cyclic siloxane compound into contact with a porous film that is composed of a Si—O bond in the absence of a metal catalyst, not only hydrophobic property but also mechanical strength can be improved (refer to specification of International Publication WO2004/026765). This method enables to improve not only the hydrophobic property but also the mechanical strength, but further improvements of the mechanical strength are required to utilize the method for an interlayer insulating film or the like.

Further, there has been reported a method for irradiating a porous silica film having mesopores, that is a composite of cetyltrimethylammonium chloride and silica, with ultraviolet ray under a temperature of 350° C. or less and under a reduced pressure, so as to selectively remove the cetyltrimethylammonium chloride from the composite (refer to Chem. Mater., No. 12, Vol. 12, p. 3842 (2000)). According to the method, mechanical strength of the porous silica film obtained after removing the cetyltrimethylammonium chloride is higher than that before removing the cetyltrimethylammonium chloride. However, in the porous silica film obtained by the method, a problem to be solved has remained that a methyl group which is a hydrophobic group present on a mesopore surface is also removed, and therefore hygroscopicity increases for that removal and specific dielectric constant increases.

As described above, a technique for producing a porous silica film that is preferably applicable to an optical functional material, an electronic functional material or the like has been developing, but a technique is not sufficiently developed at present by which a porous silica film that satisfies both the hydrophobic property and the mechanical strength of the film is produced from a silica composite that is obtained by using as an organic compound a surfactant capable of increasing the porosity and decreasing the specific dielectric constant.

### DISCLOSURE OF INVENTION

An object of the invention is to provide a method for producing, with the use of a surfactant, porous silica and a porous silica film that have low specific dielectric constant and high mechanical strength and are preferably applicable to optical functional materials, electronic functional materials or the like, and a method for producing, with the use of the porous silica film, an interlayer insulating film, a semiconductor material and a semiconductor apparatus, and a producing apparatus for producing the sames.

After earnestly studying to solve the above problems, the inventors have succeeded in obtaining desired porous silica and a porous silica film, and the inventors have thus achieved the invention.

The invention provides a method for producing porous silica, comprising the steps of: irradiating a composite obtained by drying a solution containing a hydrolysis-condensation product of alkoxysilanes and a surfactant, with ultraviolet ray; and subsequently treating the composite with an organic silicon compound having an alkyl group.

Further, in the invention it is preferable that the organic silicon compound having an alkyl group has, in one molecule, one or more Si—X—Si bonds (wherein X represents an oxygen atom, a group —NR—, an alkylene group that has 1 or 2 carbon atoms or a phenylene group, and R represents an alkyl group that has 1 to 6 carbon atoms or a phenyl group), and two or more Si-A bonds (wherein A represents a hydrogen atom, a hydroxyl group, an alkoxy group that has 1 to 6 carbon atoms, a phenoxy group or a halogen atom).

Further, in the invention it is preferable that the composite is irradiated with an ultraviolet ray at a temperature in a range of 10 to 350° C.

Further, the invention provides a method for producing a porous silica film comprising the steps of: forming a film-like composite by drying a solution containing a hydrolysis-condensation product of alkoxysilanes and a surfactant; irradiating the film-like composite with an ultraviolet ray; and subsequently treating the composite with an organic silicon compound having an alkyl group to form porous silica.

Further, the invention provides a method for producing an interlayer insulating film comprising the steps of: forming a film-like composite by drying a solution containing a hydrolysis-condensation product of alkoxysilanes and a surfactant; irradiating the film-like composite with an ultraviolet ray; and subsequently treating the composite with an organic silicon compound having an alkyl group to producing a porous silica film.

Further, the invention provides a method for producing a semiconductor material comprising the steps of: forming a film-like composite by drying a solution containing a hydrolysis-condensation product of alkoxysilanes and a surfactant; irradiating the film-like composite with an ultraviolet ray; and subsequently treating the composite with an organic silicon compound having an alkyl group to producing a porous silica film.

Further, the invention provides a method for producing a semiconductor apparatus comprising the steps of: forming a film-like composite by drying a solution containing a hydrolysis-condensation product of alkoxysilanes and a surfactant; irradiating the film-like composite with an ultraviolet ray; and subsequently treating the composite with an organic silicon compound having an alkyl group to producing a porous silica film.

Further, the invention provides an apparatus for producing a porous silica film, comprising a treatment chamber for consecutively carrying out the steps of: irradiating a film-like composite formed by drying a solution containing a hydrolysis-condensation product of alkoxysilanes and a surfactant, with an ultraviolet; and subsequently treating the composite with an organic silicon compound having an alkyl group.

Further, the invention provides an apparatus for producing a porous silica film, comprising: a first airtight treatment chamber for irradiating a film-like composite formed by drying a solution containing a hydrolysis-condensation product of alkoxysilanes and a surfactant, with an ultraviolet ray; and a second airtight treatment communicated with the first airtight treatment chamber, for treating the composite having been irradiated with the ultraviolet ray, with an organic silicon compound having an alkyl group.

### BRIEF DESCRIPTION OF DRAWINGS

Other and further objects, features, and advantages of the invention will be more explicit from the following detailed description taken with reference to the drawings wherein:

FIG. 1 is a view schematically showing an embodiment of an apparatus for producing a porous silica film according to the invention;

FIG. 2 is a view schematically showing an embodiment of a producing apparatus according to the invention, in which only two steps, an ultraviolet-ray irradiation step and a hydrophobic treatment step, are carried out consecutively; and

FIG. 3 is a view schematically showing another embodiment of the producing apparatus according to the invention, in which only two steps, the ultraviolet-ray irradiation step and the hydrophobic treatment step, are carrying out consecutively.

### BEST MODE FOR CARRYING OUT THE INVENTION

Now referring to the drawings, preferred embodiments of the invention are described below.

A producing method according to the invention comprises: (1) a composite forming step in which a solution containing a hydrolysis-condensation product of alkoxysilanes and a surfactant is dried to from a composite; (2) an ultraviolet-ray irradiation step in which the composite obtained at the step (1) is irradiated with ultraviolet ray; and (3) a hydrophobic treatment step in which the composite irradiated with the ultraviolet ray is treated with an organic silicon compound having an alkyl group.

Porous silica is obtained by the producing method according to the invention. The porous silica preferably has an average pore diameter in a range of 0.5 nm to 10 nm. If the average diameter is in the above range, it is possible to provide both of sufficient mechanical strength and low specific dielectric constant.

Note that the average pore diameter of the porous silica herein was measured by a nitrogen adsorption method at a temperature of liquid nitrogen (77K) by the use of a three-sample type automatic gas adsorption measurement device (trade name: AUTOSORB-3B, manufactured by Quantachrome Instruments Corp). In addition, specific surface area was obtained by a BET method and pore distribution was obtained by a BJH method.

(1) Composite Forming Step

A composite produced in the step is a precursor of porous silica. The porous structure herein refers to a structure that has an opening allowing water molecules to freely enter from outside and having a diameter smaller than 100 nm, and that has pores whose length in a depth direction is larger than the dimension of the opening. The pores herein also include gaps between particles.

Further, the porous silica produced in the step is a porous silica that is mainly composed of a Si—O bond, and may partially include an organic material. The wording “mainly composed of a Si—O bond” merely means that at least two Si atoms are bonded to a Si atom through an O atom, and matters other than the bonding relationship between Si atoms and O atom are not limited in particular. For example, a hydrogen, a halogen atom, an alkyl group, a phenyl group, or a functional group containing these atoms or groups may be partially bonded to the Si atom. Typically, silica, silsesquioxane hydride, methylsilsesquioxane, methylsiloxane hydride, dimethylsiloxane and the like are included.

In the step, firstly, silica sol is obtained by hydrolysis and dehydration condensation of alkoxysilanes. The hydrolysis and the dehydration condensation of the alkoxysilanes are capable of being carried out in accordance with a known method, for example, carried out by mixing the alkoxysilanes, a catalyst, water, and if necessary, a solvent.

Further, when the hydrolysis and the dehydration condensation of the alkoxysilanes are carried out, an organic compound for template (pore forming agent) may also be mixed. A surfactant or the like is preferably applicable as the organic compound for template.

(Alkoxysilanes)

As the alkoxysilanes, known alkoxysilanes may be used without any restrictions and examples thereof include quaternary alkoxysilanes such as tetramethoxysilane, tetraethoxysilane, tetraisopropoxysilane and tetrabutoxysilane; tertiary alkoxyfluorosilanes such as trimethoxyfluorosilane, triethoxyfluorosilane, triisopropoxyfluorosilane and tributoxyfluorosilane; fluorine-containing alkoxysilanes such as CF₃ (CF₂)₃CH₂CH₂Si (OCH₃)₃, CF₃ (CF₂)₅CH₂CH₂Si (OCH₃)₃, CF₃ (CF₂)₇CH₂ CH₂Si (OCH₃)₃, CF₃ (CF₂)₉CH₂CH₂Si (OCH₃)₃, (CF₃)₂CF(CF₂)₄CH₂CH₂Si(OCH₃)₃, (CF₃)₂CF(CF₂)₆CH₂CH₂Si(OCH₃)₃, (CF₃)₂CF(CF₂)₈CH₂CH₂Si(OCH₃)₃, CF₃(C₆H₄)CH₂CH₂Si(OCH₃)₃, CF₃(CF₂)₃(C₆H₄)CH₂CH₂Si(OCH₃)₃, CF₃(CF₂)₅(C₆H₄)CH₂CH₂Si(OCH₃)₃, CF₃ (CF₂)₇(C₆H₄) CH₂CH₂Si (OCH₃)₃, CF₃ (CF₂)₃CH₂CH₂SiCH₃ (OCH₃)₂, CF₃ (CF₂)₅CH₂CH₂SiCH₃ (OCH₃)₂, CF₃ (CF₂)₇CH₂CH₂SiCH₃ (OCH₃)₂, CF₃(CF₂)₉CH₂CH₂SiCH₃(OCH₃)₂, (CF₃)₂CF(CF₂)₄CH₂CH₂SiCH₃(OCH₃)₂, (CF₃)₂CF (CF₂)₆CH₂CH₂SiCH₃ (OCH₃)₂, (CF₃)₂CF (CF₂)₈CH₂CH₂SiCH₃ (OCH₃)₂, CF₃ (C₆H₄) CH₂CH₂SiCH₃ (OCH₃)₂, CF₃ (CF₂)₃(C₆H₄) CH₂CH₂SiCH₃ (OCH₃)₂, CF₃ (CF₂)₅(C₆H₄) CH₂CH₂SiCH₃ (OCH₃)₂, CF₃ (CF₂)₇(C₆H₄) CH₂CH₂SiCH₃ (OCH₃)₂, CF₃ (CF₂)₃CH₂CH₂Si (OCH₂CH₃)₃, CF₃ (CF₂)₅CH₂CH₂Si (OCH₂CH₃)₃, CF₃ (CF₂)₇CH₂CH₂Si (OCH₂CH₃)₃ and CF₃(CF₂)₉CH₂CH₂Si (OCH₂CH₃)₃; tertiary alkoxyalkylsilanes such as trimethoxymethylsilane, triethoxymethylsilane, trimethoxyethylsilane, triethoxyethylsilane, trimethoxypropylsilane and triethoxypropylsilane; tertiary alkoxyarylsilanes such as trimethoxyphenylsilane, triethoxyphenylsilane, trimethoxychlorophenylsilane and triethoxychlorophenylsilane; tertiary alkoxyphenethylsilanes such as trimethoxyphenethylsilane and triethoxyphenethylsilane; and secondary alkoxyalkylsilanes such as dimethoxydimethylsilane and diethoxydimethylsilane. Among them, the quaternary alkoxysilanes are preferable, and the tetraethoxysilane is especially preferable. Alkoxysilanes may be used singly, or two or more thereof may be used in combination.

(Catalyst)

As the catalyst, one or more of catalysts selected from an acid catalyst and an alkali catalyst may be used.

As the acid catalyst, there may be used the known inorganic acids and organic acids. Examples of the inorganic acids include hydrochloric acid, nitric acid, sulfuric acid, hydrofluoric acid, phosphoric acid, boric acid and hydrobromic acid. In addition, as the organic acids, examples thereof include acetic acid, propionic acid, butanoic acid, pentanoic acid, hexanoic acid, heptanoic acid, octanoic acid, nonanoic acid, decanoic acid, oxalic acid, maleic acid, methylmalonic acid, adipic acid, sebacic acid, gallic acid, butyric acid, mellitic acid, arachidonic acid, shikimic acid, 2-ethylhexanoic acid, oleic acid, stearic acid, linoleic acid, linolenic acid, salicylic acid, benzoic acid, p-aminobenzoic acid, p-toluensulfonic acid, benzensulfonic acid, monochloroacetic acid, dichloroacetic acid, trichloroacetic acid, trifluoroacetic acid, formic acid, malonic acid, sulfonic acid, phthalic acid, fumaric acid, citric acid, tartaric acid, succinic acid, itaconic acid, mesaconic acid, citraconic acid and malic acid.

Examples of the alkali catalyst include ammonium salt and a nitrogen-containing compound. Examples of the ammonium salt include tetramethylammonium hydroxide, tetraethylammonium hydroxide, tetrapropylammonium hydroxide and tetrabutylammonium hydroxide. Examples of the nitrogen-containing compound include pyridine, pyrrole, piperidine, 1-methylpiperidine, 2-methylpiperidine, 3-methylpiperidine, 4-methylpiperidine, piperazine, 1-methylpiperazine, 2-methylpiperazine, 1,4-dimethylpiperazine, pyrrolidine, 1-methylpyrrolidine, picoline, monoethanolamine, diethanolamine, dimethylmonoethanolamine, monomethyldiethanolamine, triethanolamine, diazabicyclooctane, diazabicyclononane, diazabicycloundecene, 2-pyrazoline, 3-pyrroline, quinuclidine, ammonia, methylamine, ethylamine, propylamine, butylamine, N,N-dimethylamine, N,N-diethylamine, N,N-dipropylamine, N,N-dibutylamine, trimethylamine, triethylamine, tripropylamine and tributylamine.

(Solvent)

Examples of the solvent used for preparing coating liquid include monoalcohol-based solvents, such as methanol, ethanol, n-propanol, i-propanol, n-butanol, i-butanol, sec-butanol, t-butanol, n-pentanol, i-pentanol, 2-methylbutanol, sec-pentanol, t-pentanol, 3-methoxybutanol, n-hexanol, 2-methylpentanol, sec-hexanol, 2-ethylbutanol, sec-heptanol, heptanol-3, n-octanol, 2-ethylhexanol, sec-octanol, n-nonyl alcohol, 2,6-dimethylheptanol-4, n-decanol, sec-undecyl alcohol, trimethylnonyl alcohol, sec-tetradecyl alcohol, sec-heptadecyl alcohol, phenol, cyclohexanol, methylcyclohexanol, 3,3,5-trimethylcyclohexanol, benzylalcohol, phenylmethylcarbinol, diacetonalcohol and cresol; polyhydric alcohol-based solvents, such as ethylene glycol, 1,2-propylene glycol, 1,3-butylene glycol, pentandiol-2,4,2-methylpentandiol-2,4, hexanediol-2,5, heptanediol-2,4,2-ethylhexanediol-1,3, diethylene glycol, dipropylene glycol, triethylene glycol, tripropylene glycol and glycerin; ketone-based solvents such as acetone, methylethyl ketone, methyl-n-propyl ketone, methyl-n-butyl ketone, diethyl ketone, methyl-1-butyl ketone, methyl-n-pentyl ketone, ethyl-n-butyl ketone, methyl-n-hexyl ketone, di-1-butyl ketone, trimethylnonanone, cyclohexanone, 2-hexanone, methylcyclohexanone, 2,4-pentanedione, acetonylacetone, diacetone alcohol, acetophenone and fenchone; ether-based solvents, such as ethyl ether, i-propyl ether, n-butyl ether, n-hexyl ether, 2-ethylhexyl ether, ethylene oxide, 1,2-propylene oxide, dioxolane, 4-methyldioxolane, dioxane, dimethyldioxane, ethylene glycol monomethyl ether, ethylene glycol monoethyl ether, ethylene glycol diethyl ether, ethylene glycol mono-n-butyl ether, ethylene glycol mono-n-hexyl ether, ethylene glycol monophenyl ether, ethylene glycol mono-2-ethyl butyl ether, ethylene glycol dibutyl ether, diethylene glycol monomethyl ether, diethylene glycol monoethyl ether, diethylene glycol diethyl ether, diethylene glycol mono-n-butyl ether, diethylene glycol di-n-butyl ether, diethylene glycol mono-n-hexyl ether, ethoxytriglycol, tetraethylene glycol di-n-butyl ether, propylene glycol monomethyl ether, propylene glycol monoethyl ether, propylene glycol monopropyl ether, propylene glycol monobutyl ether, dipropylene glycol monomethyl ether, dipropylene glycol monoethyl ether, tripropylene glycol monomethyl ether, tetrahydrofuran and 2-methyltetrahydrofuran; and ester-based solvents, such as diethyl carbonate, methyl acetate, ethyl acetate, γ-butyrolactone, γ-valerolactone, acetic acid n-propyl, acetic acid i-propyl, acetic acid n-butyl, acetic acid i-butyl, acetic acid sec-butyl, acetic acid n-pentyl, acetic acid sec-pentyl, acetic acid 3-methoxybutyl, methylpentyl acetate, acetic acid 2-ethylbutyl, acetic acid 2-ethylhexyl, benzyl acetate, cyclohexyl acetate, methylcyclohexyl acetate, acetic acid n-nonyl, methyl acetoacetate, ethyl acetoacetate, ethylene glycol monomethyl ether acetate, ethylene glycol monoethyl ether acetate, diethylene glycol monomethyl ether acetate, diethylene glycol monoethyl ether acetate, diethylene glycol mono-n-butyl ether acetate, propylene glycol monomethyl ether acetate, propylene glycol monoethyl ether acetate, propylene glycol monopropyl ether acetate, propylene glycol monobutyl ether acetate, dipropyleneglycol monomethyl ether acetate, dipropyleneglycol monoethyl ether acetate, glycol diacetate, methoxytriglycol acetate, propionic acid ethyl, propionic acid n-butyl, propionic acid i-amyl, oxalic acid diethyl, oxalic acid di-n-butyl, methyl lactate, ethyl lactate, n-butyl lactate, n-amyl lactate, diethyl malonate, dimethyl phthalate and diethyl phthalate; and nitrogen-containing solvents, such as N-methylformamide, N,N-dimethylformamid, N,N-diethylformamid, acetamide, N-methylacetamide, N,N-dimethylacetamide, N-methylpropionamide and N-methylpyrrolidone. Solvents may be used singly, or two or more thereof may be used in combination.

(Surfactant)

As the surfactant, there may be used surfactants which are commonly used in this field, for example, a compound having a long-chain alkyl group and a hydrophilic group, a compound having polyalkylene oxide structure, or the like can be used.

As the long-chain alkyl group in the compound having a long-chain alkyl group and a hydrophilic group, a long-chain alkyl group that has 8 to 24 carbon atoms is preferable, and a long-chain alkyl group that has 10 to 18 carbon atoms is more preferable. In addition, examples of the hydrophilic group include a quaternary ammonium base, an amino group, a nitroso group, a hydroxyl group and carboxyl group, and it is preferable to use the quaternary ammonium base, the hydroxyl group or the like among them.

Specific examples of the compound having a long-chain alkyl group and a hydrophilic group include alkylammonium salt represented by the following general formula (1):

C₉H_{2g+1}[N(CH₃)₂(CH₂)ₕ]ₐ(CH₂)_{b}N(CH₃)₂CᵢH2ᵢ₊₁X₍₁₊ₐ₎ (1)

(wherein “a” is an integer of 0 to 2, “b” is an integer of 0 to 4, “g” is an integer of 8 to 24, “h” is an integer of 0 to 12, and “i” is an integer of 1 to 24, respectively, and X is a halide ion, HSO₄⁻ or a monovalent organic anion). The alkylammonium salt forms micelles depending on its concentration and arranges them regularly. In the invention, silica and surfactant form a composite using the micelles as template, and when the template is removed, then a porous film having uniform pores is prepared.

Examples of the polyalkylene oxide structure in the compound having a polyalkylene oxide structure include a polyethylene oxide structure, a polypropylene oxide structure, a polytetramethylene oxide structure and a polybutylene oxide structure.

Specific examples of the compound having the polyalkylene oxide structure include ether type compounds such as polyoxyethylene-polyoxypropylene block copolymer, polyoxyethylene-polyoxybutylene block copolymer, polyoxyethylene-polyoxypropylene alkyl ether, polyoxyethylene alkyl ether and polyoxyethylene alkyl phenyl ether; and ether ester type compounds such as polyoxyethylene glycerine fatty acid ester, polyoxyethylene sorbitan fatty acid ester, polyethylene sorbitol fatty acid ester, sorbitan fatty acid ester, propylene glycol fatty acid ester and sucrose fatty acid ester.

The surfactant may be used singly, or two or more thereof may be used in combination.

The surfactant and the alkoxysilanes are used in combination as appropriate and the mole ratio between them is changed if necessary, and thereby it is also possible to form porous silica having a periodic pore structure such as a 2D-hexagonal structure, a 3D-hexagonal structure and a cubic structure.

(Other Components)

For example, an organic amphoteric electrolyte is capable of being mixed with a silica sol prepared in the step, in order to improve the preservation stability. Examples of the organic amphoteric electrolyte include amino acid and amino acid polymer. Any of the well-known amino acids can be used and examples thereof include azaserine, asparagine, aspartic acid, aminobutyric acid, alanine, arginine, alloisoleucine, allothreonine, isoleucine, ethionine, ergothioneine, ornithine, canavaline, kynurenine, glycine, glutamine, glutamic acid, creatine, sarcosine, cystathionine, cystine, cysteine, cysteic acid, citrulline, serine, taurine, thyroxine, tyrosine, tryptophan, threonine, norvaline, norleucine, valine, histidine, 4-hydroxy-L-proline, hydroxyl-L-lysine, phenylalanine, proline, homoserine, methionine, 1-methyl-L-histidine, 3-methyl-L-histidine, L-lanthionine, L-lysine and L-leucine, but in particular, use of the glycine is preferable. Examples of the amino acid polymer include oligopeptide bonded by peptide bonds of 2 to 10 amino acids and polypeptide bonded by peptide bonds of more than 10 amino acids. Specific examples of these peptides include carnosine, glutathione and diketopiperazine. The organic amphoteric electrolyte may be used singly, or two or more thereof may be used in combination.

(Mixing of Respective Components)

Forms (such as solid, liquid and solution dissolved in solvent), mixture order and mixture amount in the case of mixing the respective components (alkoxysilanes, catalyst, water, solvent, surfactant, and if necessary, organic amphoteric electrolyte) are selected as appropriate without any restrictions in response to design performance of the finally obtained porous silica, but it is preferable that water is mixed in two steps in order to control hydrolysis and dehydration condensation of the alkoxysilanes. In the first step, the amount of from 0.1 to 0.3 mole, preferably from 0.2 to 0.25 mole of water is mixed, based on 1 mole of alkoxy group of the alkoxysilanes. In the second step, the mixture amount of water may be selected as appropriate from a wide range without any restrictions, but preferably in the amount of from 1 to 10 moles, based on 1 mole of alkoxy group of the alkoxysilanes. Interval (time) between the first step and the second step may be selected as appropriate without any particular restrictions in response to use amounts of the respective components and the design performance of the finally obtained porous silica. A use amount of the catalyst may be selected as appropriate without any particular restrictions, so as to promote hydrolysis and dehydration condensation of the alkoxysilanes, but the catalyst is preferably used in the amount of from 0.1 to 0.001 mole, based on 1 mole of the alkoxysilanes. In a case where the solvent is used, a use amount of the solvent may be selected, without any particular restrictions, from a range where hydrolysis and dehydration condensation reactions of the alkoxysilanes can be smoothly progressed and drying of the obtained silica sol can be easily carried out, but it is preferable that the solvent is used in the amount of from 100 to 10,000 parts by weight, more preferably from 300 to 4000 parts by weight, based on 100 parts by weight of the alkoxysilanes. In addition, a use amount of the surfactant may be also selected from a wide range, without any particular restrictions, in response to the use amounts of the respective components and the design performance of porous silica as a final target object, but it is preferable that the surfactant is used in the amount of from 0.002 to 1 mole, more preferably from 0.005 to 0.15 mole, based on 1 mole of the alkoxysilanes.

The hydrolysis and dehydration condensation reactions of the alkoxysilanes by mixing the above respective components are carried out under stirring and under a temperature of 0° C. to 70° C., preferably 30° C. to 50° C., and finished in several minutes to 5 hours, preferably 1 to 3 hours. Thereby, a silica sol is obtained.

In the step, a composite is obtained by drying the silica sol prepared in this manner, and the drying operation is important for obtaining porous silica having the low specific dielectric constant and the high mechanical strength. That is to say, solvent, alcohols that have been generated by the hydrolysis of the alkoxysilanes, and the like are removed in the drying step, but partial dehydration condensation of the silica sol is carried out and thereby the composite is hardened. Without this preliminary hardening by the drying, the structure is collapsed due to insufficient strength of a silica skeleton when the surfactant is removed by the ultraviolet-ray irradiation, resulting in a failure to obtain a desirable porosity, i.e., the low specific dielectric constant. A temperature required for the preliminary hardening is in a rage of 80 to 180° C., preferably 100 to 150° C. If the temperature is in the above range, the dehydration condensation of the silica sol is advanced, but the surfactant is scarcely removed from the composite. For the drying time, one minute or longer is enough, but in view of efficiency, 1 to 60 minutes are preferable because a hardening speed is extremely reduced after a certain time has passed. The drying is carried out under the above conditions, and thereby the condensation of the silica sol is preliminarily advanced, resulting that the structure of the silica sol is maintained even when the surfactant is removed. As the method for drying the silica sol, any known methods are employable without any particular restrictions, and in order to obtain a film-like composite, the silica sol may be applied onto a substrate, thereafter being dried. Note that the control on making the film-like composite porous can be carried out, for example, by changing kinds of the above components, especially the alkoxysilanes, the surfactant or the like.

As a substrate onto which the silica sol is applied, any substrates that are typically used are employable. Examples thereof include glass, quartz, silicon wafer and stainless steel. In particular, when the obtained porous silica film is used as a semiconductor material, the silicon wafer is preferably applicable. In addition, the substrate may have any shapes, such as plate-like and dish-like shapes.

As a method for applying the silica sol onto the substrate, examples thereof include typical methods such as a spin coating method, a casting method and a dip coating method. In the case of the spin coating method, the substrate is placed on a spinner, followed by dropping of the silica sol on the substrate which is made to rotate at a rate of 500 to 10,000 rpm, resulting in a film that is excellent in surface smoothness and uniform in thickness. The obtained film is treated under the above-mentioned drying conditions.

(2) Ultraviolet-ray Irradiation Step

In the step, the composite obtained at the above step (1), that is a precursor of the porous silica, is irradiated with the ultraviolet ray. By irradiating the composite with the ultraviolet ray, the surfactant is removed from the composite so as to make the composite porous and strengthen a Si—O—Si bond, and thereby the mechanical strength is improved. Note that, when the surfactant remains in the composite, the remaining surfactant forms adsorption sites of water which decreases the specific dielectric constant of the porous silica, so that the irradiation of the ultraviolet ray is preferably carried out under a condition that the surfactant in the composite is all removed.

In the step, conditions for the irradiation of the ultraviolet ray (such as wavelength of the ultraviolet ray, ultraviolet intensity, atmosphere in emitting the ultraviolet ray, distance between a composite and a light source for emitting the ultraviolet ray, a temperature of the emitted ultraviolet ray, and a length of time for the irradiation of the ultraviolet ray) may be selected as appropriate, without any particular restrictions, so that the surfactant in the composite is all removed.

The wavelength of the ultraviolet ray is preferably in a range of 100 to 350 nm, more preferably in a range of 170 to 250 nm. The irradiation of the ultraviolet ray having a wavelength in the above range allows for removal of the surfactant while strengthening the silica bond.

The ultraviolet intensity influences, for example, the removal time of the surfactant or the like, and the removal time of the surfactant becomes shorter as the ultraviolet intensity becomes higher, but in view of an operation by an ultraviolet irradiation apparatus, the ultraviolet intensity is preferably in a range of 5 to 100 mW/cm².

The atmosphere in emitting the ultraviolet ray is not limited in particular as far as it is not in an oxidizing atmosphere, and the ultraviolet ray is emitted preferably in an inert atmosphere of nitrogen or the like, in vacuum, or the like, and more preferably in a nitrogen atmosphere. In a case where oxygen is present, the oxygen absorbs the ultraviolet ray to form ozone and the ultraviolet ray may not reach to the silica sufficiently, and it is therefore necessary to be careful.

An impeccable distance between the composite and the light source for emitting the ultraviolet ray is such a distance that the ultraviolet ray emitted from the light source reaches to the composite and the composite is irradiated with the ultraviolet ray uniformly, and the distance is preferably in a range of 1 to 10 cm.

The temperature of the emitted ultraviolet ray influences the strength of the porous silica to be obtained. It is predicted that, as the temperature becomes higher, the bond is rearranged more frequently in order to strengthen the silica skeleton. On the other hand, in a semiconductor production, if the temperature is too high, there is concern that other components are affected, causing performance deterioration. Accordingly, the temperature of the emitted ultraviolet ray is preferably in a range of 10 to 350° C., more preferably in a range of 150 to 350° C., and especially preferably in a range of 200 to 350° C. Since the length of time for the irradiation of the ultraviolet ray is capable of being shortened when the temperature is increased, basically, the temperature is preferably set so that the treatment is finished in several minutes. The length of time for the irradiation of the ultraviolet ray may be extended, but from the viewpoint of the economic efficiency, it is preferable that the temperature of the emitted ultraviolet ray is set so that the length of time for the irradiation falls within 5 minutes. In the case of a film formed by CVD, when the length of time for the irradiation of the ultraviolet ray is extended, a value of the specific dielectric constant k is increased to the contrary, possibly because the shrinkage progresses and pores become so small that a cut functional group in the film can not go out from the film, but in the case of a porous film formed by the surfactant, pores are so large that such phenomenon does not occur.

Note that, it is also possible to remove the surfactant before irradiation of the ultraviolet ray with an alternative method such as a thermal treatment, but when alkoxysilane not having a methyl group is used as a raw material to form a composite and the surfactant is removed from the composite, then a hydrophobic group does not present on the surface and the silica bond is weak, resulting that water is more likely to be adsorbed and a film is likely to shrink rapidly. Accordingly, it is not preferable that the surfactant is removed from the composite before irradiation of the ultraviolet ray with an alternative method.

(3) Hydrophobic Treatment Step

In the step, the hydrophobic treatment is applied to the porous silica treated with the ultraviolet ray, whereby an increase of the specific dielectric constant over time due to moisture adsorption is hardly seen, resulting in a porous silica film having low specific dielectric constant and high mechanical strength, which film is preferably applicable as an interlayer insulating film or the like.

According to examinations by the inventors, it was found that the increase in the specific dielectric constant with the elapse of time, the shrinkage of the film and the like are caused in the obtained porous silica, just by irradiating the composite containing surfactant as an organic compound for template with the ultraviolet ray. That is to say, by the irradiation of the ultraviolet ray, an organic material that is to be bonded to the silica is removed and a hydrophilic organic group such as a methyl group on the surface of the silica is also removed, and then a silanol group that is to be an adsorption site of water is generated thereon to adsorb water. Accordingly, it would appear that the specific dielectric constant increases regardless of the strengthening of the Si—O—Si bond in the silica skeleton owing to the irradiation of the ultraviolet ray. In addition, if the intensity of the emitted ultraviolet ray is low, the strength in the silica skeleton is insufficient and more silanol groups are generated, resulting that the structure is collapsed due to water adsorption and the film shrinkage is caused. That is to say, since the porous structure formed by using the surfactant as an organic compound for template has large pores, it is predicted that the porous structure is more likely to be affected by water molecules, compared with a porous structure formed without using the organic compound for template.

Further, according to examinations by the inventors, it was found that the composite is irradiated with the ultraviolet ray to obtain the porous silica, followed by subjecting the porous silica to a hydrophobic treatment with an organic silicon compound having an alkyl group, and thereby the specific dielectric constant does not increase with the elapse of time and is kept low even in the porous silica formed by using the surfactant as the organic compound for template. This is because the organic silicon compound having an alkyl group has high reactivity for a silanol group and is reacted with the silanol group to make the surface of the silica hydrophobic. On the other hand, in a case of a typical film formed by CVD or the like without using the surfactant, the film has no pores or has small pores, if any, and it is therefore predicted that there will not be seen examples where such a hydrophobic treatment is carried out.

As described above, in order to maintain the porous structure of the porous silica formed by using the surfactant, it is important to not only irradiate the composite with the ultraviolet ray but also apply thereto the hydrophobic treatment after the irradiation of the ultraviolet ray. By applying the hydrophobic treatment, the hydrophobicity of the porous silica irradiated with the ultraviolet ray is improved, resulting in the porous silica applicable as an interlayer insulating film or the like, in which the increase in the specific dielectric constant due to the moisture adsorption is scarcely seen while keeping high porosity (i.e. low specific dielectric constant) and high mechanical strength.

The hydrophobic treatment in the step is carried out by reacting the porous silica irradiated with the ultraviolet ray, with the organic silicon compound having an alkyl group. That is to say, through the irradiation of the ultraviolet ray, many silanol groups which are hydrophilic groups are generated on the pore surfaces of the porous silica, causing the moisture adsorption, and the hydrophobic treatment is therefore carried out by reacting with the silanol group the organic silicon compound having an alkyl group as a hydrophilic group that reacts preferentially or selectively with the silanol group.

As the organic silicon compound having an alkyl group, there may be used the known organic silicon compounds and examples thereof include an organic silicon compound (hereinafter, refereed as “organic silicon compound (A)”) that has, in one molecule, one or more Si—X—Si bonds [wherein X represents an oxygen atom, a group-NR— (R represents an alkyl group that has 1 to 6 carbon atoms or a phenyl group), and an alkylene group that has 1 to 2 carbon atoms or a phenylene group], and two or more Si-A bonds (wherein A represents a hydrogen atom, a hydroxyl group, an alkoxy group that has 1 to 6 carbon atoms or a halogen atom), and an organic silicon compound having 1 to 3 alkyl groups that have 1 to 4 carbon atoms such as hexamethyldisilazane(HMDS) and trimethylsilyl chloride (TMSC). Among these compounds, in view of the improvement degree of the mechanical strength or the like of the obtained porous silica, the organic silicon compound (A) is preferable. If the organic silicon compound (A) is reacted, the siloxane bond is rearranged including this compound, resulting that further improvement of the mechanical strength is expected.

Specific examples of the organic silicon compound (A) include cyclic siloxane (hereinafter, referred as “cyclic siloxane (2)”) represented by the following formula (2):

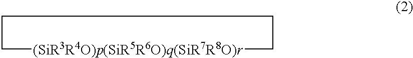

(In the formula (2), R³, R⁴, R⁵, R⁶, R⁷ and R⁸ are the same or different, and respectively represent a hydrogen atom, a hydroxyl group, a phenyl group, an alkyl group that has 1 to 3 carbon atoms, CF₃(CF₂)_{c}(CH₂)_{b}, and an alkenyl group that has 2 to 4 carbon atoms or a halogen atom. Wherein, at least two of p-number of R³ and R⁴, q-number of R⁵ and R⁶, and r-number of R⁷ and R⁸ represent a hydrogen atom, a hydroxyl group or a halogen atom. “c” represents an integer of 0 to 10, and “b” represents the same as the mentioned above. “p” represents an integer of 0 to 8, “q” represents an integer of 0 to 8, “r” represents an integer of 0 to 8, which satisfies 3≦p+q+r≦8.); a siloxane compound (hereinafter, referred as “siloxane compound (3)”) represented by the following formula (3):

Y—SiR¹⁰R¹¹-Z-SiR¹²R¹³—Y (3)

(In the formula (3), R¹⁰, R¹¹, R¹² and R¹³ are the same or different, and respectively represent a hydrogen atom, a phenyl group, an alkyl group that has 1 to 3 carbon atoms, CF₃(CF₂)C(CH₂)_{b} or a halogen atom. Z represents O, an alkylene group that has 1 to 6 carbon atoms, a phenylene group, (OSiR¹⁴R¹⁵)cO, O—SiR¹⁶R¹⁷—W—SiR¹⁸R¹⁹—O or NR²⁰. R¹⁴, R¹⁵, R¹⁶, R¹⁷, R¹⁸, R¹⁹ and R²⁰ are the same or different, and respectively represent a hydrogen atom, a hydroxyl group, a phenyl group, an alkyl group that has 1 to 3 carbon atoms, CF₃(CF₂)_{c}(CH₂)_{b}, and a halogen atom or OSiR²¹R²²R²³. W represents an alkylene group that has 1 to 6 carbon atoms or a phenylene group. R²¹, R²² and R²³ are the same or different, and respectively represent a hydrogen atom or a methyl group. Two Ys are the same or different, and respectively represent a hydrogen atom, a hydroxyl group, a phenyl group, an alkyl group that has 1 to 3 carbon atoms, CF₃(CF₂)_{c}(CH₂)_{b} or a halogen atom. “b” and “c” represent the same as the mentioned above. Wherein, at least two of R¹⁰, R¹¹, R¹², R¹³ and two Xs represent a hydrogen atom and a hydroxyl atom or a halogen atom.); and a cyclic silazane (hereinafter, referred as “cyclic silazane (4)) represented by the following formula (4):

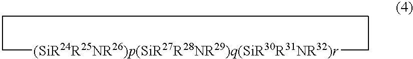

(In the formula (4), “p”, “q” and “r” represent the same as the mentioned above. R²⁴, R²⁵, R²⁷, R²⁸, R³⁰ and R³¹ the same or different, and respectively represent a hydrogen atom, a hydroxyl group, a phenyl group, an alkyl group that has 1 to 3 carbon atoms, and CF₃(CF₂)_{c}(CH₂)_{b} or a halogen atom. Wherein, at least two of p-number of R²⁴ and R²⁵, q-number of R²⁷ and R²⁸ and r-number of R³⁰ and R³¹ represent a hydrogen atom, a hydroxyl group or a halogen atom. R²⁶, R²⁹ and R³² are the same or different, and respectively represent a phenyl group, and an alkyl group that has 1 to 3 carbon atoms or CF₃(CF₂)_{c}(CH₂)_{b}. “b” and “c” represent the same as the mentioned above.)

Specific examples of the cyclic siloxane (2) include (3,3,3-trifluoropropyl)methylcyclotrisiloxane, triphenyltrimethylcyclotrisiloxane, 1,3,5,7-tetramethylcyclotetrasiloxane, octamethylcyclotetrasiloxane, 1,3,5,7-tetramethyl-1,3,5,7-tetraphenylcyclotetrasiloxane, tetraethylcyclotetrasiloxane and pentamethylcyclopentasiloxane. Among them, the 1,3,5,7-tetramethylcyclotetrasiloxane is preferable.

Specific examples of the siloxane compound (3) include 1,2-bis(tetramethyldisiloxanyl)ethane, 1,3-bis(trimethylsiloxy)-1,3-dimethyldisiloxane, 1,1,3,3,5,5-hexamethyltrisiloxane, 1,1,3,3-tetraisopropyldisiloxane, 1,1,4,4-tetramethyldisilethylene and 1,1,3,3-tetramethyldisiloxane.

Specific examples of the cyclic silazane (4) include 1,2,3,4,5,6-hexamethylcyclotrisilazane, 1,3,5,7-tetraethyl-2,4,6,8-tetramethylcyclotetrasilazane and 1,2,3-triethyl-2,4,6-triethylcyclotrisilazane.

The organic silicon compound having an alkyl group may be used singly, or two or more thereof may be used in combination.

The reaction of the porous silica and the organic silicon compound having an alkyl group is capable of being executed in the same manner as the conventionally known reaction methods, in a liquid phase or in a gas phase atmosphere.

In a case where the reaction is executed in the liquid phase, an organic solvent may be used. As the applicable organic solvents, examples thereof include alcohols such as methanol, ethanol, n-propyl alcohol and isopropyl alcohol; ethers such as diethyl ether, diethylene glycol dimethyl ether, 1,4-dioxane and tetrahydrofuran; and arylalkanes such as benzene, toluene and xylene. When the reaction is executed in the organic solvent (hydrophobic treatment), concentration of the organic silicon compound having alkyl group may be selected as appropriate, without any particular restrictions, from a wide range in accordance with various reaction conditions such as kinds of the organic silicon compound, kinds of the organic solvent and reaction temperature.

In a case where the reaction is executed in the gas phase atmosphere, the organic silicon compound having an alkyl group may be diluted with gas. Examples of the applicable dilution gases include air, nitrogen, argon and hydrogen. In addition, it is possible to execute the reaction under reduced pressure instead of the dilution with gas. Especially, it is more preferable to execute the reaction in the gas phase atmosphere, because steps of collecting and drying solvents are not required. When the organic silicon compound having an alkyl group is diluted, there is no limitation to the concentration of the organic silicon compound as far as the concentration is 0.1 vol % or more. In addition, the arbitrarily diluted gas is applicable in any methods such as bringing into contact with the organic silicon compound by flowing, bringing into contact with the organic silicon compound by recycling, or bringing into contact with the organic silicon compound in a state of being enclosed in a sealed vessel. The reaction temperature is not limited in particular and the reaction may be executed at a temperature not lower than a temperature at which the organic silicon compound having an alkyl group as a hydrophobic agent reacts with the porous silica and not higher than a temperature at which the hydrophobic agent is not decomposed and not subject to side reactions except for the target reaction, but the temperature is preferably in a range of 10 to 500° C., more preferably in a range of 10 to 350° C. in consideration of an upper limit for the process. Note that, in a case where the organic silicon compound (A) is used, the reaction temperature is preferably in a range of 300 to 350° C. If the reaction temperature is in the above range, the reaction proceeds smoothly and effectively without causing side reactions. A heating method is not limited in particular as far as a substrate on which the porous silica is formed is capable of being heated uniformly, and examples thereof include a hot plate method and an electric furnace method. A method for raising the temperature to the reaction temperature is not limited in particular and the temperature may be increased at a prescribed rate gradually, and in addition, when the reaction temperature is lower than a firing temperature of the silica, there is no problem even if the organic silicon compound (A) is inserted at one dash into a reaction vessel whose temperature has reached the reaction temperature. The reaction time of the porous silica and the organic silicon compound having an alkyl group may be selected as appropriate in response to the reaction temperature, and the reaction time is typically for 2 minutes to 40 hours and preferably for 2 minutes to 4 hours.

Further, water may be present in a reaction system of the porous silica and the organic silicon compound (A). The presence of water in the reaction system is preferable because the reaction of the porous silica and the organic silicon compound (A) is promoted. The usage amount of water may be selected as appropriate in response to kinds of the organic silicon compound (A), and water is preferably used so that a partial pressure of water in the reaction system falls in a range of 0.05 to 25 kPa. If the partial pressure is within the above range, an effect to promote the reaction of water is sufficiently exerted and moreover, the pore structure of the porous silica is not collapsed by water. Furthermore, a temperature of water added to the reaction system is not limited in particular as far as the temperature is equal to or lower than the reaction temperature. There is also no limitation to an adding method of water, and water may be added before bringing the porous silica into contact with the organic silicon compound (A) and may be added to the reaction system together with the organic silicon compound (A).

In this way, the film-like porous silica is obtained. The porous silica has both low specific dielectric constant and high mechanical strength, and the increase in the specific dielectric constant due to water adsorption and the shrinkage of the film are not caused in the porous silica. It is possible to confirm that the obtained porous silica film has an average pore diameter of 0.5 to 10 nm by TEM observation for cross section of the film and pore distribution measurement. In addition, a thickness of the film is in a range of around 0.05 to 2 μm, but is different depending on producing conditions.

The porous silica film according to the invention may be being a self-supporting film or being formed on the substrate. In addition, the porous silica film does not generate any trouble such as clouding and coloring after a series of processes, and therefore the porous silica film is applicable also when transparent one is needed.

In the invention, the hydrophobicity of the porous silica film is confirmed by measuring the specific dielectric constant. It is possible to obtain the specific dielectric constant based on electrical capacity of an aluminum electrode generated with vapor deposition method on a surface of the porous silica film on the silicon substrate and a rear surface of a silicon wafer used for the substrate, that is measured at a temperature of 25° C., under an atmosphere of relative humidity of 50%, with a frequency of 100 kHz, and in a range of −40 V to 40 V, and based on a film thickness measured by Spectroscopic ellipsometer (trade name: GES5, manufactured by SOPRA).

Further, the mechanical strength of the porous silica film according to the invention is confirmed by measuring elastic modulus of the film using nanoindentation measurement. The nanoindentation measurement was carried out with Triboscope System manufactured by Hysitron.

An apparatus for producing a porous silica film according to the invention will be described below. The apparatus for producing the porous silica film according to the invention is an apparatus that consecutively executes series of processes, i.e., a composite forming step (1), an ultraviolet-ray irradiation step (2) and a hydrophobic treatment step (3), respectively. Especially, it is important that the ultraviolet-ray irradiation step (2) and the hydrophobic treatment step (3) are preformed consecutively, in order to obtain a stable performance of the porous silica film. In addition, at the ultraviolet-ray irradiation step (2), the surface of the film needs to be irradiated with the ultraviolet-ray uniformly, and therefore it is preferable that the apparatus is an apparatus that processes per sheet.

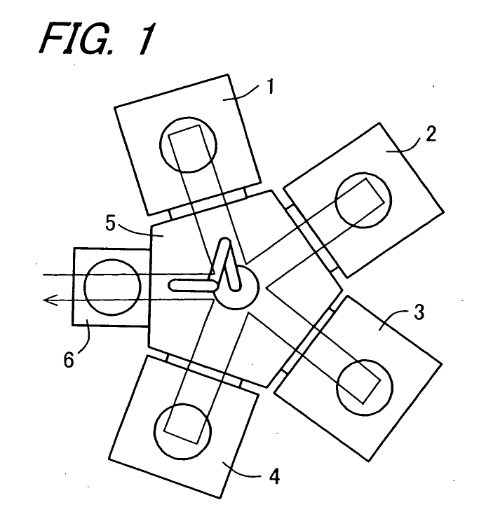

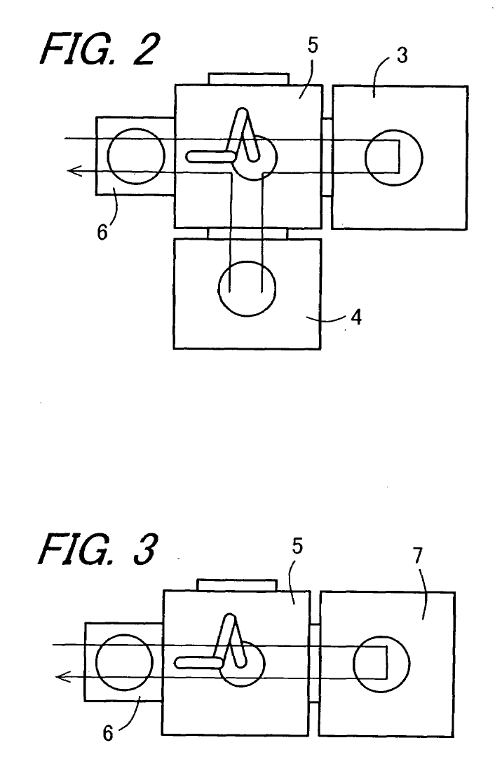

FIG. 1 shows a specific embodiment of the apparatus, and FIG. 2 and FIG. 3 shows embodiments of the apparatus where only two steps of the ultraviolet-ray irradiation step (2) and the hydrophobic treatment step (3) are carried out consecutively. The apparatus in FIG. 1 comprises an application chamber 1 in which a solution containing a hydrolysis-condensation product of alkoxysilanes and a surfactant is applied to a substrate, a drying chamber 2 in which the applied solution is dried to form a composite, an ultraviolet-ray irradiation chamber 3 in which the composite is irradiated with the ultraviolet ray, a hydrophobic treatment chamber 4 in which the composite is hydrophobized by a treatment with an organic silicon compound having an alkyl group, a robot arm chamber in which the substrate is carried in and out from the treatment chambers 1 to 4 by a robot arm, and a FOUP (Front-Opening Unified Pod) 6 for delivering and storing the substrate. The treatment chambers 1 to 4 and the robot arm chamber 5 are capable of being made airtight individually. In addition, the treatment chambers 1 to 4 and the FOUP 6 are communicated one another by the robot arm chamber 5.

The apparatus in FIG. 2 comprises only the ultraviolet-ray irradiation chamber 3, the hydrophobic treatment chamber 4, the robot arm chamber 5 and the FOUP 6. A composite is formed by another apparatus. In the apparatus of FIG. 3, the ultraviolet-ray irradiation chamber 3 and the hydrophobic treatment chamber 4 are integrated into an ultraviolet-ray irradiation and hydrophobic treatment chamber 7 that performs the irradiation of the ultraviolet ray and the hydrophobic treatment. The chamber 7 is also capable of being made airtight.

In the invention, at the composite forming step (1), the drying at a temperature of 80 to 180° C., preferably at a temperature of 100 to 150° C., is carried out and the surfactant has remained in the pores without being removed, and therefore, till the ultraviolet-ray irradiation step (2), the composite may be brought into contact with the air while water is not adsorbed into the pores, resulting that the performance of the porous silica film is not affected even in the apparatus in which only two steps of the ultraviolet-ray irradiation step (2) and the hydrophobic treatment step (3) are carried out consecutively.

In either case, an apparatus used for the respective steps may be configured by connecting the typically used apparatuses as far as the above-mentioned conditions in the producing method are satisfied. It is desirable to perform the processes consecutively since there can be stably obtained the porous silica films that are excellent in hydrophobicity and mechanical strength.

The porous silica film according to the invention is so excellent in both hydrophobicity and mechanical strength as to be applicable for an optical functional material or an electronic functional material such as an interlayer insulating film, a molecular recording medium, a transparent conductive film, solid electrolyte, an optical waveguide, and a color member for LCD. In particular, such a porous silica film according to the invention, that is excellent in hydrophobicity and mechanical strength, is preferably used for an interlayer insulating film as a semiconductor material, which requires strength, heat resistance and low specific dielectric constant.

Next, there will be specifically described an embodiment of a semiconductor apparatus according to the invention, in which the porous silica film is used as an interlayer insulating film.

Firstly, as described above, the composite is formed on a surface of a silicon wafer, irradiated with the ultraviolet ray, and then reacted with an organic silicon compound having an alkyl group, preferably with the organic silicon compound (A), to form a porous silica film. Next, the porous silica film is etched in accordance with a photoresist pattern. After the etching of the porous silica film, a barrier film composed of titanium nitride (TiN), tantalum nitride (TaN) or the like is formed on the surface of the porous silica film and an etched portion, with a vapor deposition method. Then, a copper film is formed thereon with a metal CVD method, a sputtering method, an electrolytic plating method or the like and further, an unnecessary copper film is removed therefrom by a CMP (chemical mechanical polishing) process to form circuit wiring. Furthermore, a cap film (such as a film composed of silicon carbide) is formed on the surface and a hard mask (such as a film composed of silicon nitride) is formed, if necessary. These steps are repeated so as to be multilayered, and thereby the semiconductor apparatus according to the invention is capable of being produced.

The invention is now more specifically illustrated below with reference to the following examples, although the invention is not restricted to these examples. Note that Examples were carried out with an apparatus having the above-mentioned constitution in FIG. 2.

### Example 1

### Preparation of a Silica Sol and Production of a Composite Film

After 10.0 g of tetraethoxysilane (manufactured by Japan Pure Chemical Co., Ltd., EL, Si(OC₂H₅)₄)) and 10 mL of ethanol (manufactured by Wako Pure Chemical Industries, Ltd., EL, C₂H₅OH) were mixed and stirred at room temperature, 1.0 mL of 1 normal hydrochloric acid (manufactured by Wako Pure Chemical Industries, Ltd., for analyzing trace metal) was added thereto and stirred at a temperature of 50° C. Subsequently, 4.2 g of polyoxyethylene (20) stearyl ether (manufactured by Sigma Chemical Co., C₁₈H₃₇(CH₂CH₂O)₂OH)) that has been dissolved in 40 mL of ethanol was added thereto and mixed. To the mixed solution thus obtained was added 8.0 mL of water (9.2 mole based on 1 mole of tetraethoxysilane) and stirred at a temperature of 30° C. for 50 minutes, and then added and mixed was 10 mL of 2-butanol (manufactured by Kanto Chemical Co., Inc., CH₃(C₂H₅)CHOH),) in which 0.056 g of glycine (manufactured by Mitsui Chemicals, Inc., H₂NCH₂COOH)) has been dissolved, followed by stirring at a temperature of 30° C. for 70 minutes.

The obtained solution was dropped on a surface of a silicon wafer which is then made to rotate at a rate of 2,000 rpm for 60 seconds so that the surface of the silicon wafer is coated with the solution, following by drying at a temperature of 150° C. for 1 minute to produce a composite film.

[Ultraviolet Irradiation to a Composite Film and a Hydrophobic Treatment]

The composite film obtained above was horizontally placed in a stainless steel reactor and an ultraviolet irradiation lamp having a wavelength of 172 nm and an output of 8 mW/cm² was installed on a position which is 6 cm above the composite film. The inside of the reactor was depressurized to a pressure lower than 600 Pa and the ultraviolet ray was emitted at a temperature of 350° C. for 5 minutes. After the irradiation of the ultraviolet ray, the film was subsequently left alone at room temperature for 3 hours in saturated steam of hexamethyldisilazane (manufactured by Wako Pure Chemical Industries, Ltd., (CH₃)₃SiNHSi(CH₃)₃) that has been balanced by N₂ so as to be made hydrophobic, resulting that the porous silica film of the invention was obtained. The specific dielectric constant k of the porous silica film and film strength E (elastic ratio, GPa) obtained by the nanoindentation measurement are shown in table 1 below.

### Example 2

A porous silica film was produced under the same conditions as those of Example 1 except that the temperature in emitting the ultraviolet ray was changed from 350° C. to 200° C. The specific dielectric constant k of the film and the film strength E are shown in Table 1 below.

### Example 3

A porous silica film was produced under the same conditions as those of Example 2 except that the wavelength of the ultraviolet ray was changed from 172 nm to 222 nm. The specific dielectric constant k of the film and the film strength E are shown in Table 1 below.

### Example 4

A porous silica film was produced under the same conditions as those of Example 2 except that the wavelength of the ultraviolet ray was changed from 172 nm to 308 nm. The specific dielectric constant k of the film and the film strength E are shown in Table 1 below.

### Example 5

A porous silica film was produced under the same conditions as those of Example 1 except that the hydrophobic treatment was carried out at a temperature of 350° C. for 10 minutes, instead of at a room temperature for 3 hours. The specific dielectric constant k of the film and the film strength E are shown in Table 1 below.

### Example 6

A porous silica film was produced under the same conditions as those of Example 5 except that HMDS was changed to 1,3,5,7-tetramethylcyclotetrasiloxane (manufacture by AZmax CO., (TMCTS), (SiH(CH₃)O)₄). The specific dielectric constant k of the film and the film strength E are shown in Table 1 below.

### Comparative Example 1

A porous silica film was produced under the same conditions as those of Example 1 except that the hydrophobic treatment after the irradiation of the ultraviolet ray was not carried out. The specific dielectric constant k of the film and the film strength E are shown in Table 1 below.

### Comparative Example 2

A porous silica film was produced under the same conditions as those of example 1 except that the irradiation of the ultraviolet ray at a temperature of 350° C. for 5 minutes was not carried out. The specific dielectric constant k of the film and the film strength E are shown in Table 1 below.

### Comparative Example 3

After 3.5 g of methyltriethoxysilane (manufactured by Yamanaka Hutech Co., Ltd., CH₃Si(OC₂H₅)₃), 6.0 g of tetoraethoxysilane and 10 mL of ethanol were mixed and stirred at room temperature, 1.0 mL of 1 normal hydrochloric acid was added thereto and stirred at a temperature of 50° C. After 40 mL of ethanol was added thereto and mixed, 8.0 mL of water (9.2 mol, based on 1 mol of silane) was added there to and stirred at a temperature of 30° C. for 50 minutes, 10 mL of 2-butanol in which 0.056 g of glycine has been dissolved was added thereto and mixed, followed by stirring at a temperature of 30° C. for 70 minutes, resulting that a solution is prepared.

The solution was turned into a film under the same conditions as those of Example 1, and the irradiation of the ultraviolet ray and the hydrophobic treatment were carried out. The specific dielectric constant k of the obtained film and the film strength E are shown in table 1 below.

### Comparative Example 4

A porous silica film was produced under the same conditions as those of Example 1 except that the ultraviolet ray was emitted directly after the obtained solution was applied to the surface of the silicon wafer, without interposing drying at a temperature of 150° C. for 1 minute. The specific dielectric constant k of the film and the film strength E are shown in table 1 below.

TABLE 1

| | | Dielectric Constant k | Film Strength E (GPa) |
|---|---|---|---|
| Examples | 1 | 2.4 | 8.2 |
| | 2 | 2.4 | 4.8 |
| | 3 | 2.5 | 6.1 |
| | 4 | 2.6 | 5.5 |
| | 5 | 2.3 | 8.0 |
| | 6 | 2.4 | 9.0 |
| Comparative | 1 | >10 | Unmeasurable due to film |
| Examples | | | shrinkage |
| | 2 | 2.3 | 3.0 |
| | 3 | 1.7 | 2.6 |
| | 4 | 5.7 | 16.2 |

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

### INDUSTRIAL APPLICABILITY

According to the invention, porous silica and a porous silica film having both low specific dielectric constant and high mechanical strength, that are applicable to optical functional materials, electronic functional materials or the like, are capable of being produced at a relatively low temperature which is 350° C. or less. Furthermore, with the porous silica film, it is possible to easily produce, in particular, an interlayer insulating film, a semiconductor material, a semiconductor apparatus or the like.

According to the invention, it is possible to produce porous silica having low specific dielectric constant and excellent mechanical strength, that is applicable to optical functional materials, electronic functional materials or the like, and to produce an interlayer insulating film, a semiconductor material and a semiconductor apparatus of the porous silica film.

1. A method for producing porous silica, comprising the steps of:
irradiating a composite obtained by drying a solution containing a hydrolysis-condensation product of alkoxysilanes and a surfactant, with ultraviolet ray; and subsequently treating the composite with an organic silicon compound having an alkyl group.

2. The method of producing porous silica of claim 1, wherein the organic silicon compound having an alkyl group has, in one molecule, one or more Si—X—Si bonds (wherein X represents an oxygen atom, a group —NR—, an alkylene group that has 1 or 2 carbon atoms or a phenylene group, and R represents an alkyl group that has 1 to 6 carbon atoms or a phenyl group), and two or more Si-A bonds (wherein A represents a hydrogen atom, a hydroxyl group, an alkoxy group that has 1 to 6 carbon atoms, a phenoxy group or a halogen atom).

3. The method of producing porous silica of claim 2, wherein the composite is irradiated with an ultraviolet ray at a temperature in a range of 10 to 350° C.

4. A method for producing a porous silica film comprising the steps of: forming a film-like composite by drying a solution containing a hydrolysis-condensation product of alkoxysilanes and a surfactant; irradiating the film-like composite with an ultraviolet ray; and subsequently treating the composite with an organic silicon compound having an alkyl group to form porous silica.

5. A method for producing an interlayer insulating film comprising the steps of: forming a film-like composite by drying a solution containing a hydrolysis-condensation product of alkoxysilanes and a surfactant; irradiating the film-like composite with an ultraviolet ray; and subsequently treating the composite with an organic silicon compound having an alkyl group to producing a porous silica film.

6. A method for producing a semiconductor material comprising the steps of: forming a film-like composite by drying a solution containing a hydrolysis-condensation product of alkoxysilanes and a surfactant; irradiating the film-like composite with an ultraviolet ray; and subsequently treating the composite with an organic silicon compound having an alkyl group to producing a porous silica film.

7. A method for producing a semiconductor apparatus comprising the steps of: forming a film-like composite by drying a solution containing a hydrolysis-condensation product of alkoxysilanes and a surfactant; irradiating the film-like composite with an ultraviolet ray; and subsequently treating the composite with an organic silicon compound having an alkyl group to producing a porous silica film.

8. An apparatus for producing a porous silica film, comprising a treatment chamber for consecutively carrying out the steps of: irradiating a film-like composite formed by drying a solution containing a hydrolysis-condensation product of alkoxysilanes and a surfactant, with an ultraviolet; and subsequently treating the composite with an organic silicon compound having an alkyl group.

9. An apparatus for producing a porous silica film, comprising: a first airtight treatment chamber for irradiating a film-like composite formed by drying a solution containing a hydrolysis-condensation product of alkoxysilanes and a surfactant, with an ultraviolet ray; and a second airtight treatment communicated with the first airtight treatment chamber, for treating the composite having been irradiated with the ultraviolet ray, with an organic silicon compound having an alkyl group.

10. The method of producing porous silica of claim 1, wherein the composite is irradiated with an ultraviolet ray at a temperature in a range of 10 to 350° C.
